(19) United States
(12) Patent Application Publication
(10) Pub. No.: US 2020/0187654 A1
(43) Pub. Date: Jun. 18, 2020

(54) MODULAR FURNITURE SYSTEM

(71) Applicant: Rama Mutyala, Ridgecrest, CA (US)

(72) Inventor: Rama Mutyala, Ridgecrest, CA (US)

(21) Appl. No.: 16/799,803

(22) Filed: Feb. 24, 2020

Related U.S. Application Data
(60) Provisional application No. 62/814,277, filed on Mar. 5, 2019.

(51) Int. Cl. A47C 4/02; A47C 17/34; F16B 12/16; F16B 12/52

(52) U.S. Cl. CPC A47C 4/028; A47C 17/34; F16B 2012/106; F16B 12/52; A47C 4/021; F16B 12/16

(57) ABSTRACT

Disclosed is a modular furniture system such as a modular sofa assembly in the present invention. The modular sofa assembly includes a square or rectangular base that can be attached to different modules such as a side rest, a back rest, legs, cushions, and other bases to obtain various furniture items such as a single seater couch, a two seater couch, a three seater couch, or a multi-seater couch with chaise or ottomans. Further, by performing appropriate connections of the various components of the modular furniture system, a user can create tables, beds, lazy lounges, or the like. The modular sofa can be easily assembled and disassembled to obtain the various formations.

### CROSS-REFERENCE TO RELATED PATENT DOCUMENTS

This patent application claims the benefit of priority of U.S. Provisional Application No. 62/814,277 entitled “MODULAR FURNITURE SYSTEM,” filed Mar. 5, 2019, which are hereby incorporated herein by reference in its entirety.

### FIELD OF THE INVENTION

The present invention relates generally to a modular furniture system, and, more particularly, to a modular sofa that can be easily assembled and disassembled for obtaining various formations such as single seater couch to multi-seater couches with chaise or ottomans, or can create tables, beds, or lazy lounges.

### BACKGROUND

The present invention relates to a method of furniture construction in which certain of the elements thereof are modular in order to thereby permit ease of change or removal of the fabric of the back and/or other elements thereof. In the prior art, the change or removal of upholstery from a sofa, sofa-bed, loveseat, sofa-chair, and the like has constituted a difficult, expensive, and time-consuming process.

In recent times, modular furniture arrangements or sectional sofas combining plain chair-type units, beds, curves, and recliner units to form a sofa-like arrangement have become increasingly popular. Because of differences in construction of a sofa unit, a chair unit, and a recliner unit and the mixing of various other modules, in combination with the substantial weight of the completed sectional sofa unit, the joinder of separate modules into a single unit has been a problem heretofore not effectively solved.

Typical prior art solutions include use of complex, high-strength connectors to make a rigid connection between all elements. This has disadvantages in complexity and the added strength requirements for the component parts, or need for providing a high-strength frame, such as a steel frame, for all components. Additionally, there are also potential disadvantages in difficulty of disassembly, added cost, and added weight. The loads imposed by lifting the end of a sectional sofa unit cause flexing, thereby misaligning the reclining mechanism, or causing other difficulties.

In light of the foregoing, there exists a need for an improved and reliable solution that solves the above-mentioned problems and presents an advanced and easy to use modular furniture system such as a modular sofa set.

### BRIEF SUMMARY

It is an objective of the present invention to provide a modular furniture system such as a modular sofa. In an embodiment, the modular furniture system includes a square or rectangular base that can be attached to different modules (side rest, back rest), legs, cushions, and other bases to create various furniture items such as a single seater couch or a multi-seater couch with chaise or ottomans, or can create tables, beds, or lazy lounges. In a specific embodiment of the present invention, a modular sofa has been disclosed that can be easily assembled and disassembled to obtain the various formations.

These and other features and advantages of the present invention will become apparent from the detailed description below, in light of the accompanying drawings.

### BRIEF DESCRIPTION OF THE ACCOMPANYING DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of various examples. It is expressly understood, however, that the drawings are for the purpose of illustration and description only and are not intended as a definition of the limits of the invention. Embodiments of this invention will now be described by way of example in association with the accompanying drawings in which:

FIG. 1 shows a front view of a modular sofa assembly, in accordance with an embodiment of the present invention;

FIG. 2 shows a rear side view of the modular sofa assembly, in accordance with an embodiment of the present invention;

FIG. 3 shows a top view of the modular sofa assembly, in accordance with an embodiment of the present invention;

FIG. 4 shows a top perspective view of the modular sofa assembly, in accordance with an embodiment of the present invention;

FIG. 5 shows a bottom perspective view of the modular sofa assembly, in accordance with an embodiment of the present invention;

FIG. 6 shows a top view of a seat frame of the modular sofa assembly, in accordance with an embodiment of the present invention;

FIG. 7 shows a side view of the seat frame of the modular sofa assembly, in accordance with an embodiment of the present invention;

FIG. 8 shows a bottom view of the seat frame of the modular sofa assembly, in accordance with an embodiment of the present invention;

FIG. 9 shows a top perspective view of the seat frame of the modular sofa assembly, in accordance with an embodiment of the present invention;

FIG. 10 shows a bottom perspective view of the seat frame of the modular sofa assembly, in accordance with an embodiment of the present invention;

FIG. 11 shows a top perspective view of the seat frame of the modular sofa assembly, in accordance with an embodiment of the present invention;

FIG. 12 shows a front view of a sofa leg of the modular sofa assembly, in accordance with an embodiment of the present invention;

FIG. 13 shows various components of a back and side arm assembly of the modular sofa assembly, in accordance with an embodiment of the present invention;

FIG. 14 shows a top perspective view of the back and side arm assembly of the modular sofa assembly, in accordance with an embodiment of the present invention;

FIG. 15 shows a top perspective view of the back rest of the modular sofa assembly, in accordance with an embodiment of the present invention;

FIGS. 16-19 show various views of a weldment steel cap and wood assembly of the modular sofa assembly, in accordance with an embodiment of the present invention;

FIGS. 20-23 show various views of a weldment steel joiner and wood assembly of the modular sofa assembly, in accordance with an embodiment of the present invention;

FIGS. 24-26 show various views of a seat cushion of the modular sofa assembly, in accordance with an embodiment of the present invention;

FIGS. 27-29 show various views of a back cushion of the modular sofa assembly, in accordance with an embodiment of the present invention; and

FIGS. 30-32 show various views of a side cushion of the modular sofa assembly, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

As used in the specification and claims, the singular forms “a”, “an” and “the” may also include plural references. For example, the term “an article” may include a plurality of articles. Those with ordinary skill in the art will appreciate that the elements in the Figures are illustrated for simplicity and clarity and are not necessarily drawn to scale. For example, the dimensions of some of the elements in the Figures may be exaggerated, relative to other elements, in order to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of components, which constitutes a modular furniture system such as a modular sofa. Accordingly, the components have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising”, “having”, “containing”, and “including”, and other forms thereof, are intended to be equivalent in meaning and be open ended in that an item or items following any one of these words is not meant to be an exhaustive listing of such item or items or meant to be limited to only the listed item or items.

Techniques consistent with the present invention provide, among other features, the modular furniture system such as one-seater, two-seater, three-seater, or multiple-seater modular sofa. The modular furniture system includes a square or rectangular base that can be attached to different modules (side rest, back rest), legs, cushions, and other bases to obtain various furniture items such as a single seater couch or a multi-seater couch with chaise or ottomans, or can create tables, beds, or lazy lounges.

Further, in the description of the present invention, unless stated otherwise, terms such as “first” and “second” are used to arbitrarily distinguish between the elements or entities. Thus, these terms are not necessarily intended to indicate temporal or other prioritization of such elements or priorities. While various exemplary embodiments of the disclosed systems and methods have been described above, it should be understood that they have been presented for purposes of example only, and not limitations. It is not exhaustive and does not limit the invention to the precise form disclosed. Modifications and variations are possible in light of the above teachings or may be acquired from practicing of the invention, without departing from the breadth or scope of the present invention.

The modular furniture system will now be described with reference to the accompanying drawings, which should be regarded as merely illustrative without restricting the scope and ambit of the present invention.

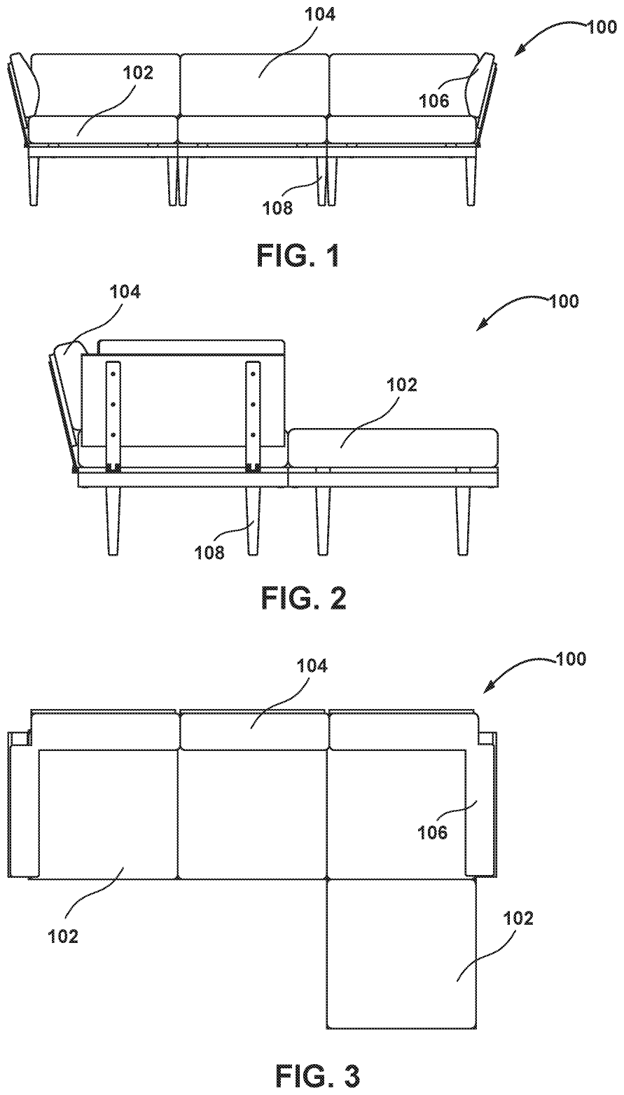

FIG. 1 shows a front view of a modular sofa assembly 100, in accordance with an embodiment of the present invention. The modular sofa assembly 100 represents a modular sofa having three seats. In an exemplary embodiment, the modular sofa assembly 100 represents a three-seat chaise modular sofa. In an embodiment, the modular sofa assembly 100 includes one or more seats. Each seat is provided with a seat cushion 102. Further, the modular sofa assembly 100 includes a back cushion 104 for resting back of a user. Further, the modular sofa assembly 100 includes a side cushion 106 for resting a hand of a user. All cushions are removably fixed to a respective base, back rest, or side rest of the modular sofa assembly 100. Further, the modular sofa assembly 100 includes multiple legs. In an exemplary embodiment, a height of each leg is 247.65 millimeter (mm). In an exemplary embodiment, a gap between two legs of a seat (as seen from the front view) is 660.40 mm. In an exemplary embodiment, a length of the modular sofa is 2495.02 mm. In an exemplary embodiment, a height of the modular sofa is 778.50 mm. In an exemplary embodiment, a height of a seat of the modular sofa from a ground surface is 457.20 mm.

FIG. 2 shows a rear side view of the modular sofa assembly 100, in accordance with an embodiment of the present invention. In an exemplary embodiment, the modular sofa assembly 100 represents a three-seat chaise modular sofa. In an embodiment, the modular sofa assembly 100 includes one or more seats. Each seat is provided with a seat cushion 102. Further, the modular sofa assembly 100 includes a back cushion 104 for resting back of a user. Further, the modular sofa assembly 100 includes a side cushion 106 for resting a hand of a user. All cushions are removably fixed to a respective base, back rest, or side rest of the modular sofa assembly 100. Further, the modular sofa assembly 100 includes multiple legs. In an exemplary embodiment, a gap between two legs (as seen from the rear side view) is 457.20 mm. In an exemplary embodiment, a length of the modular sofa along the chaise of the modular sofa is 1628.51 mm. In an exemplary embodiment, a height of a seat of the modular sofa from a ground surface is 457.20 mm.

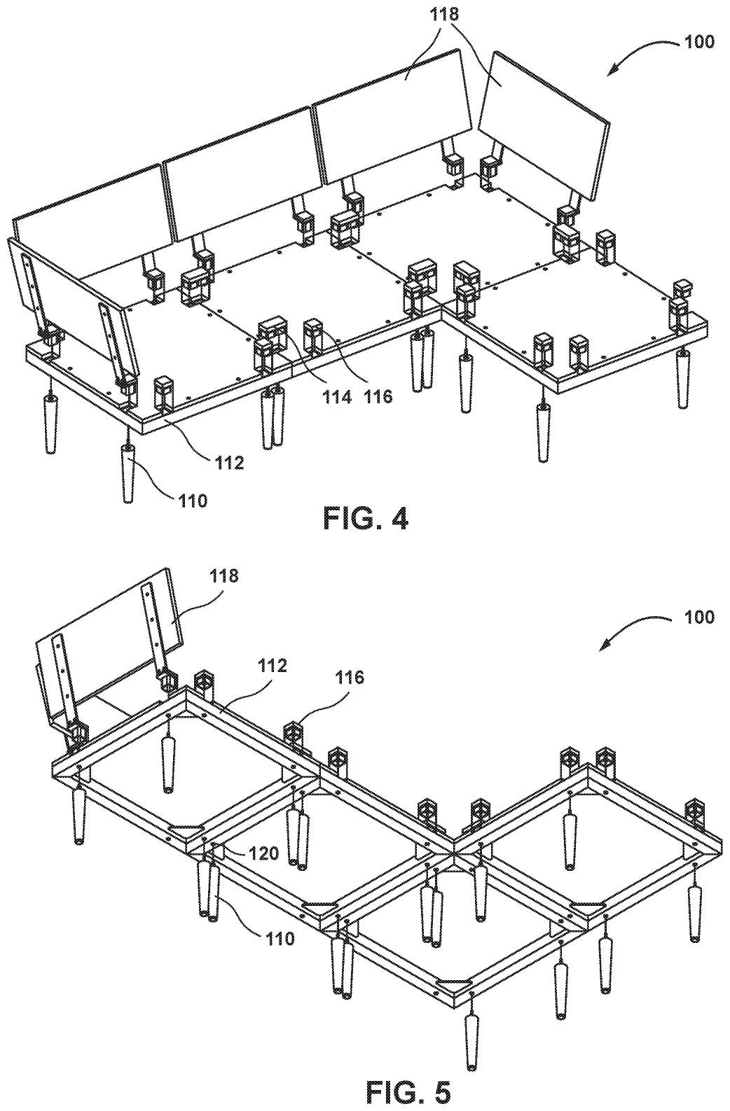

FIG. 3 shows a top view of the modular sofa assembly, in accordance with an embodiment of the present invention. In an exemplary embodiment, the modular sofa assembly 100 represents a three-seat chaise modular sofa. In an embodiment, the modular sofa assembly 100 includes one or more seats. Each seat is provided with a seat cushion 102. Further, the modular sofa assembly 100 includes a back cushion 104 for resting back of a user. Further, the modular sofa assembly 100 includes a side cushion 106 for resting a hand of a user. All cushions are removably fixed to a respective base, back rest, or side rest of the modular sofa assembly 100. In an exemplary embodiment, a width of a chaise seat of the modular sofa is 762.00 mm.

FIG. 4 shows a top perspective view of the modular sofa assembly 100, in accordance with an embodiment of the present invention. FIG. 5 shows a bottom perspective view of the modular sofa assembly 100, in accordance with an embodiment of the present invention. In an exemplary embodiment, the modular sofa assembly 100 includes a plurality of legs such as a 110. In total, the number of legs associated with the modular sofa assembly 100 is 16. Further, each leg is provided or inserted with a hanger bolt. Dimension of each sofa leg is 2″×9.75″×1.25″. The modular sofa assembly 100 includes a seat frame 112. In total, the number of seat frames associated with the modular sofa assembly 100 is 4. The seat frame 112 is made up of a wooden or metallic material. Each leg is removably attached to the seat frame 112 from the bottom by means of a hanger bolt. Dimension of the seat frame 112 is 30″×30″×2.75″. The modular sofa assembly 100 includes a weldment steel joiner and wood assembly 114. In total, the number of weldment steel joiner and wood assemblies associated with the modular sofa assembly 100 is 6. Two or more weldment steel joiner and wood assemblies 114 are used to join two seat frames. The modular sofa assembly 100 includes a weldment steel cap and wood assembly 116. In total, the number of weldment steel cap and wood assemblies associated with the modular sofa assembly 100 is 10. The modular sofa assembly 100 further includes a back and side arm assembly 118. In total, the number of back and side arm assemblies associated with the modular sofa assembly 100 is 5. Each of the back or side arm assembly is removably attached to two distinct weldment steel cap and wood assemblies. Each of the back or side arm assembly is removably connected in a tilted manner and its tilting position can be accordingly adjusted as per the user's preferences. The modular sofa assembly 100 further includes seat cushions such as the seat cushion 102. In total, the number of seat cushions associated with the modular sofa assembly 100 is 4. Dimension of each seat cushion 102 is 30″×30″×5.5″. The modular sofa assembly 100 further includes back cushions such as the back cushion 104. In total, the number of back cushions associated with the modular sofa assembly 100 is 3. Dimension of each back cushion 102 is 30″×12.44″×6″. The modular sofa assembly 100 further includes side cushions such as the side cushion 106. In total, the number of side cushions associated with the modular sofa assembly 100 is 2. Dimension of each back cushion 102 is 26.5″×13″×4″.

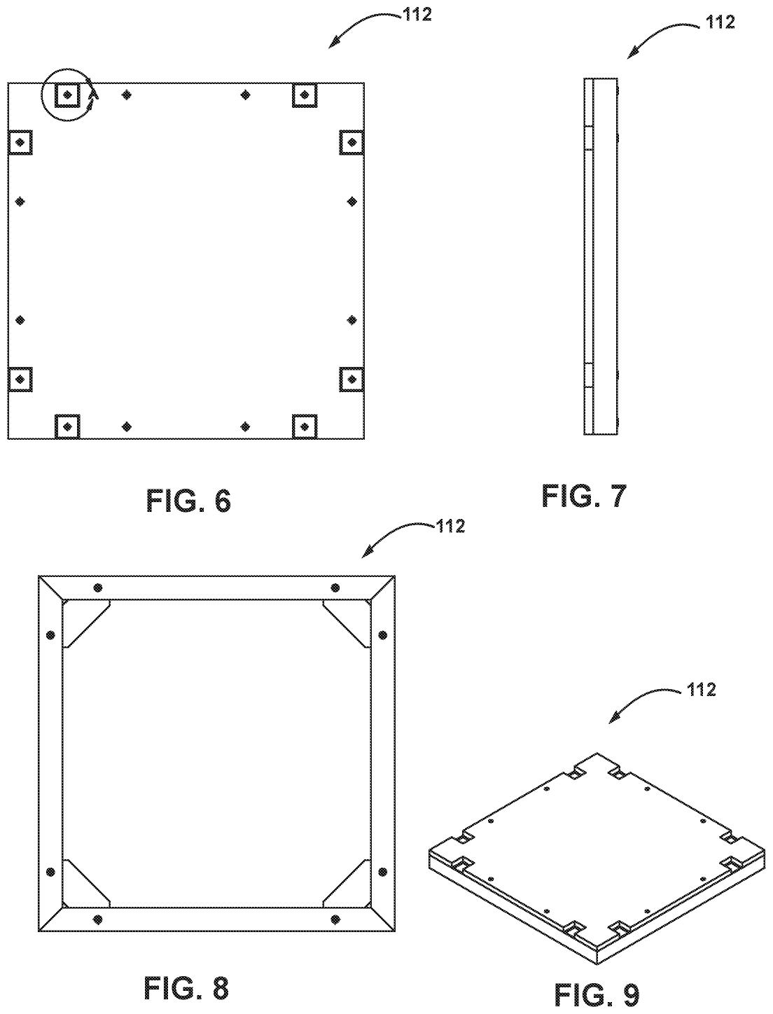

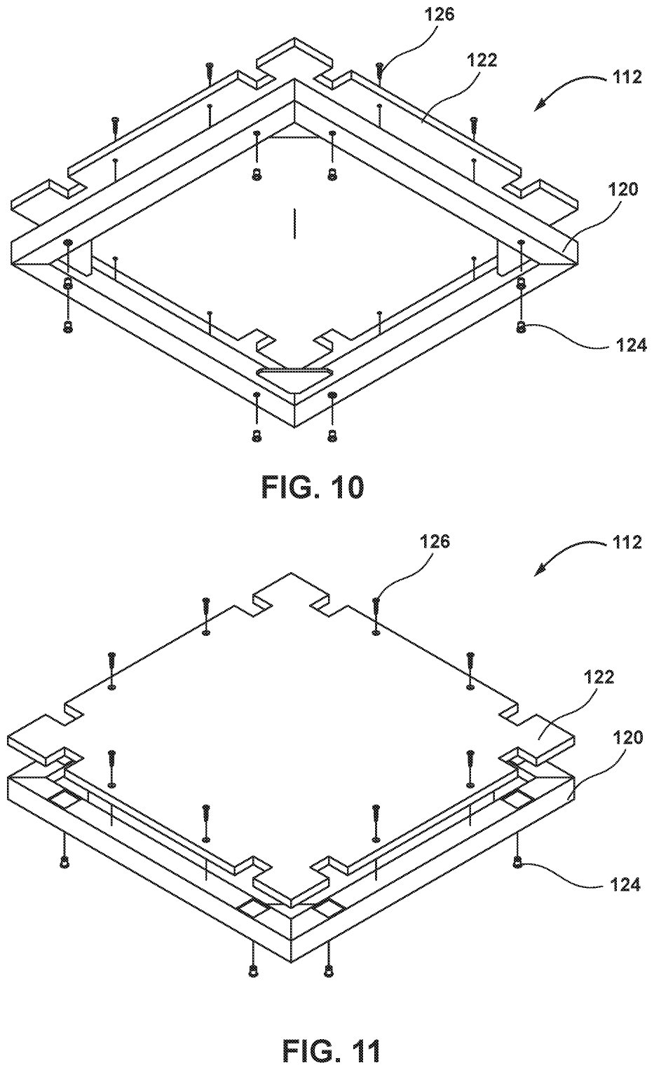

FIG. 6 shows a top view of the seat frame 112 of the modular sofa assembly 100, in accordance with an embodiment of the present invention. FIG. 7 shows a side view of the seat frame 112 of the modular sofa assembly 100, in accordance with an embodiment of the present invention. FIG. 8 shows a bottom view of the seat frame 112 of the modular sofa assembly 100, in accordance with an embodiment of the present invention. FIG. 9 shows a top perspective view of the seat frame 112 of the modular sofa assembly 100, in accordance with an embodiment of the present invention. FIG. 10 shows a bottom perspective view of the seat frame 112 of the modular sofa assembly 100, in accordance with an embodiment of the present invention. FIG. 11 shows a top perspective view of the seat frame 112 of the modular sofa assembly 100, in accordance with an embodiment of the present invention. Dimension of each seat frame 112 is 30″×30″×2″. Each seat frame 112 is made up of a metallic material. Each seat frame 112 (as shown by 120) includes a wooden seat plate 122. Dimension of each wooden seat plate 122 is 30″×30″×0.75″. Further, rivet nuts are inserted in respective slots of each seat frame 120. In total, the number of rivet nuts associated with each seat frame 120 is 11. Further, metallic self-drilling flat heads are inserted in respective slots of each wooden seat plate 122. In total, the number of metallic self-drilling flat head associated with each wooden seat plate 122 is 8. These heads are used to removably attach the wooden seat plate 122 to its seat frame 120. Each seat frame 112 includes 8 seat frame slots, 2 seat frame slots along a respective edge of each side. Similarly, each wooden seat plate 122 includes 8 wooden seat plate slots, 2 wooden seat plate slots along a respective edge of each side. The wooden seat plate slots parallelly matches with the respective seat frame slots when the wooden seat plate 122 is removably placed over the seat frame 120. The weldment steel cap and wood assembly 116 is inserted into each of these slots from the top.

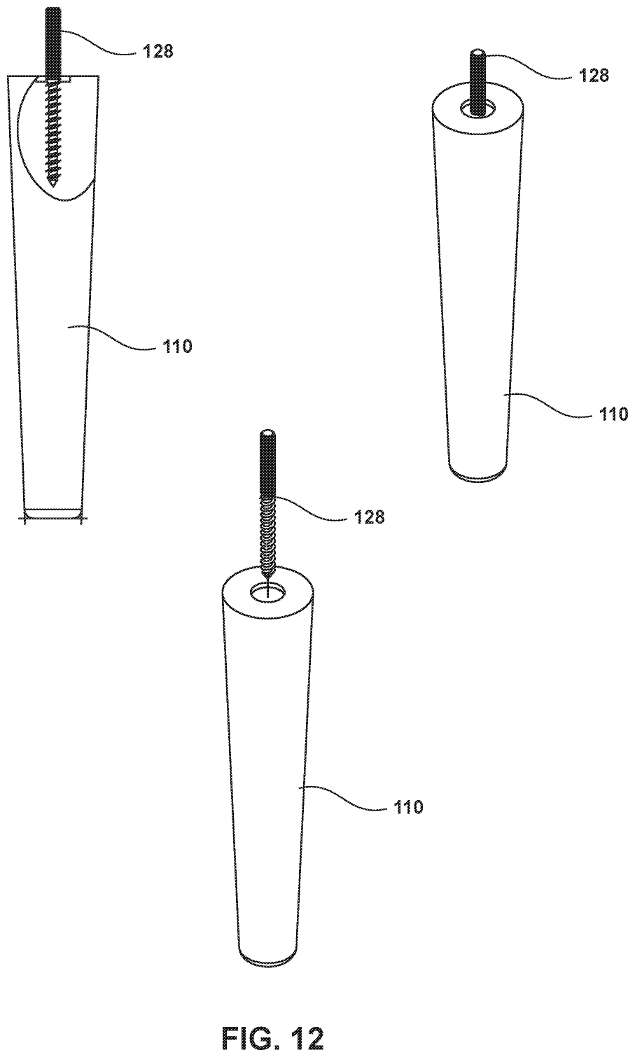

FIG. 12 shows a front view of the sofa leg 110 of the modular sofa assembly 100, in accordance with an embodiment of the present invention. The sofa leg 110 is a wooden cone-shaped leg piece. Each sofa leg is removably attached to the seat frame 112 of the modular sofa by means of a hanger bolt 128. The hanger bolt 128 has two portions. One portion of the hanger bolt 128 is inserted into the sofa leg 110 and another portion of the hanger bolt 128 is inserted into the seat frame 112.

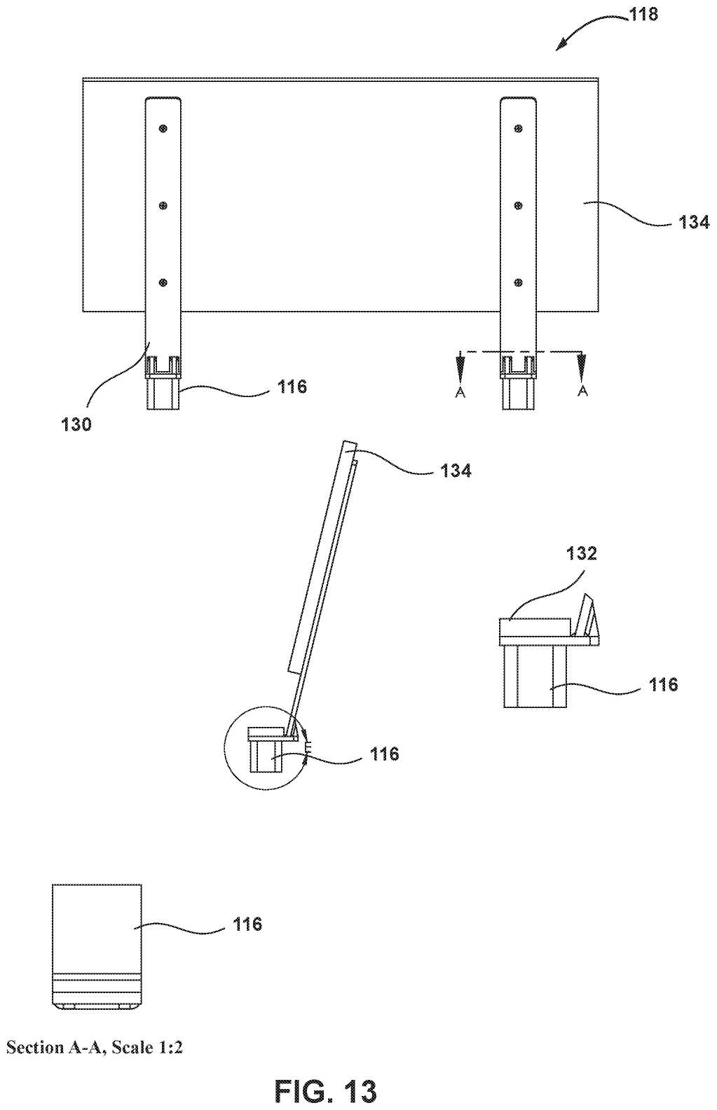

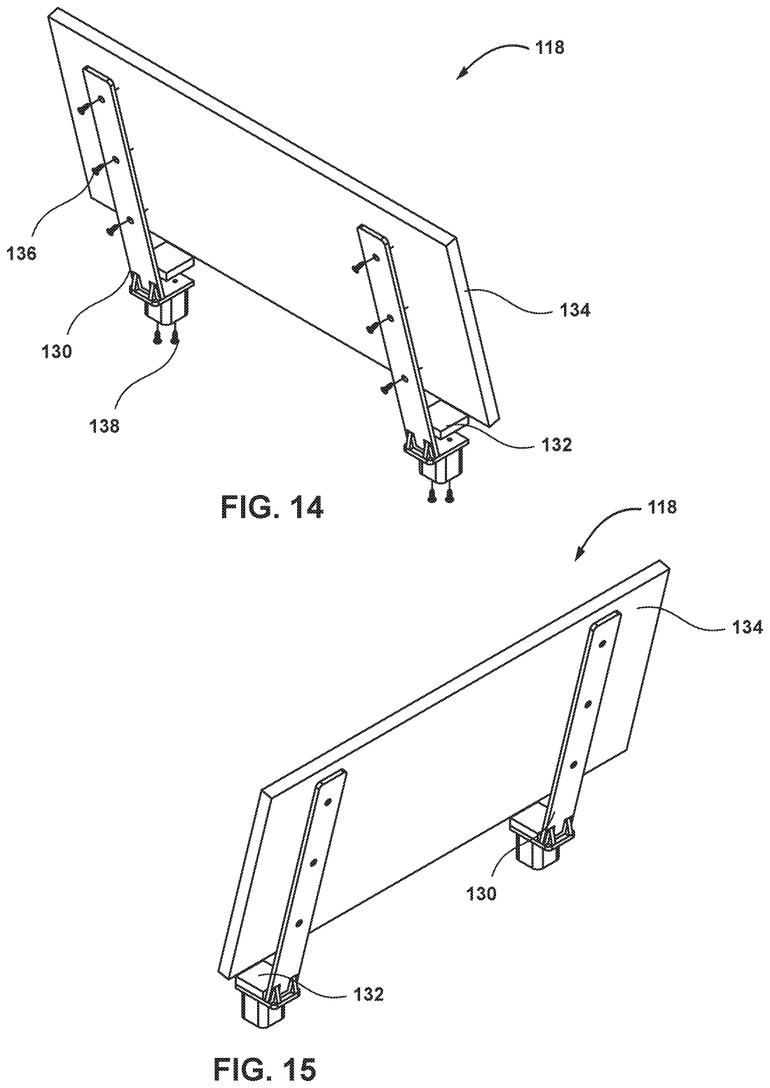

FIG. 13 shows various components of the back and side arm assembly 118 of the modular sofa assembly 100, in accordance with an embodiment of the present invention. FIG. 14 shows a top perspective view of the back and side arm assembly 118 of the modular sofa assembly 100, in accordance with an embodiment of the present invention. FIG. 15 shows a top perspective view of the back and side arm assembly 118 of the modular sofa assembly 100, in accordance with an embodiment of the present invention. Each back and side arm assembly 118 includes two weldment steel arm pieces 130. Each back and side arm assembly 118 further includes two wood pieces for arm rest 132. One weldment steel arm piece 130 and one wood piece for arm rest 132 are removably attached to the weldment steel cap and wood assembly 116 as shown in FIGS. 13-15. Each back and side arm assembly 118 further includes a back and side rest wooden piece 134. The back and side rest wooden piece 134 is removably attached to the two weldment steel arm pieces 130 by means of screws 136. In total, 6 screws 136 are used to attach the back and side rest wooden piece 134 to the two weldment steel arm pieces 130. In an exemplary embodiment, a gap between the two weldment steel arm pieces 130 is 508 mm. In an exemplary embodiment, a width of the weldment steel cap and wood assembly 116 is 44.45 mm.

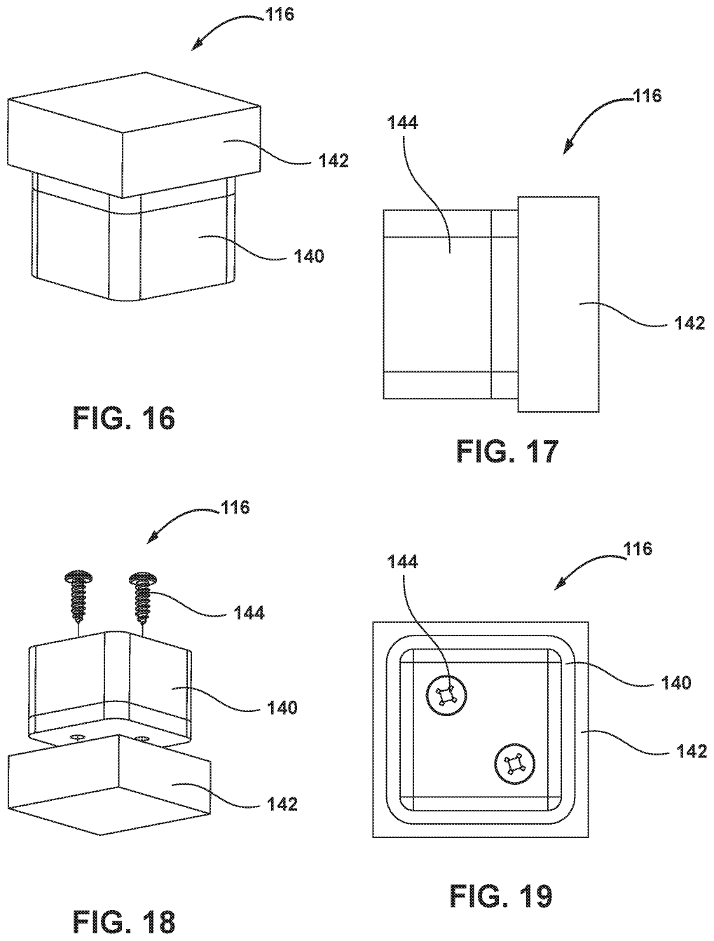

FIGS. 16-19 show various views of the weldment steel cap and wood assembly 116 of the modular sofa assembly 100, in accordance with an embodiment of the present invention. Dimension of the weldment steel cap and wood assembly 116 is 2″×2″×1.75″. The weldment steel cap and wood assembly 116 includes one piece of weldment steel cap 140. Dimension of the weldment steel cap 140 is 1.75″×1.75″×1.25″. The weldment steel cap and wood assembly 116 includes one wooden piece 142. Dimension of the wooden piece 142 is 2″×2″×0.75″. The weldment steel cap and wood assembly 116 includes two pieces of rounded head screws 144. Each rounded head screw 144 is made up of zinc plated steel. The weldment steel cap 140 is removably attached to the wooden piece 142 by means of the two pieces of rounded head screws 144.

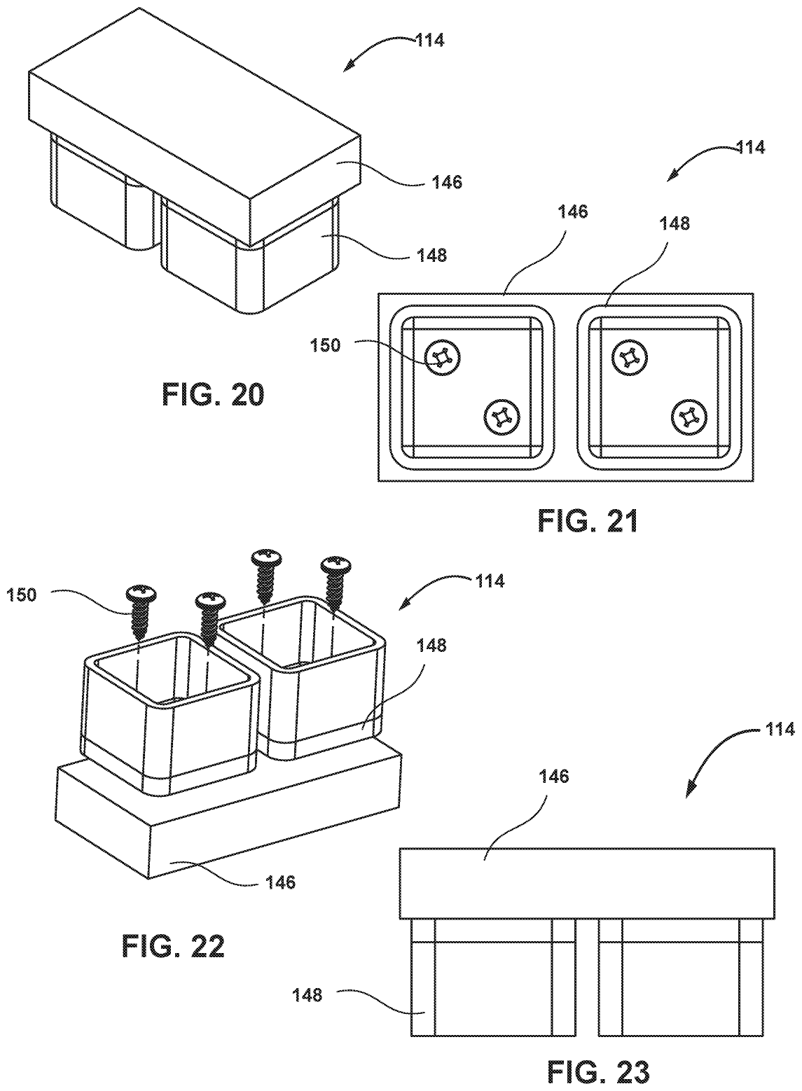

FIGS. 20-23 show various views of the weldment steel joiner and wood assembly 114 of the modular sofa assembly 100, in accordance with an embodiment of the present invention. Dimension of the weldment steel joiner and wood assembly 114 is 4″×2″×2″. The weldment steel joiner and wood assembly 114 includes one wooden piece for connector 146. Dimension of the weldment steel cap 140 is 4″×2″×0.75″. The weldment steel joiner and wood assembly 114 further includes two pieces of wooden steel caps 148. Dimension of each wooden steel cap 148 is 1.75″×1.75″×1.25″. The weldment steel joiner and wood assembly 114 further includes four pieces of rounded head screws 150. Each rounded head screw 150 is made up of zinc plated steel. Each weldment steel cap 148 is removably attached to the wooden piece for connector 146 by means of the two pieces of rounded head screws 150.

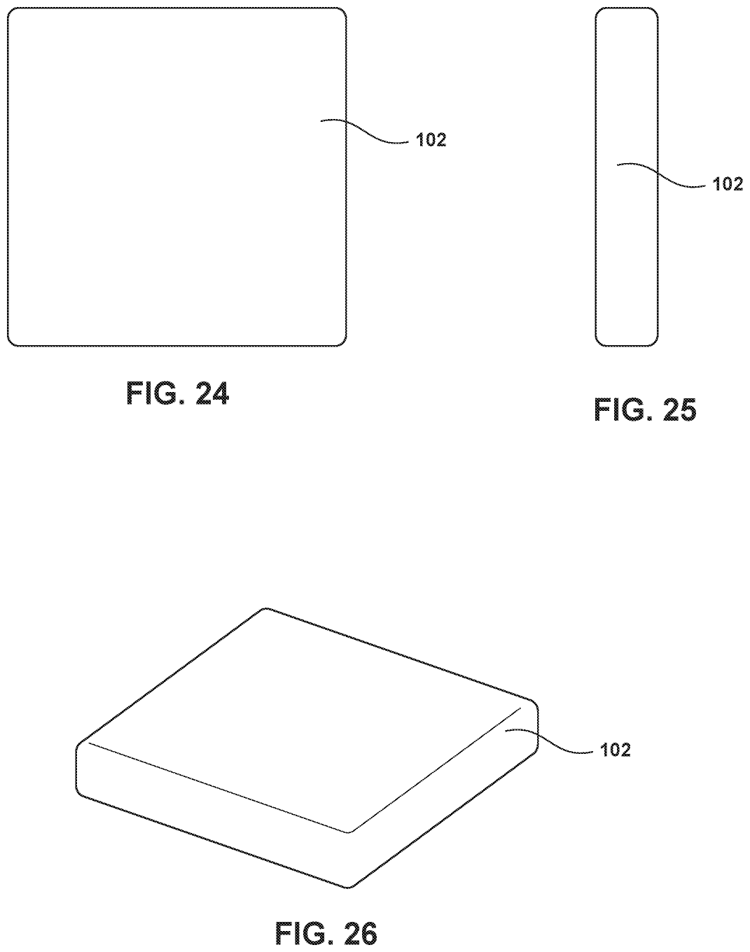

FIGS. 24-26 show various views of the seat cushion 102 of the modular sofa assembly 100, in accordance with an embodiment of the present invention. The seat cushion 102 is made up of fabric that is comfortable for sitting. Dimension of the seat cushion 102 is 30″×30″×5.50″.

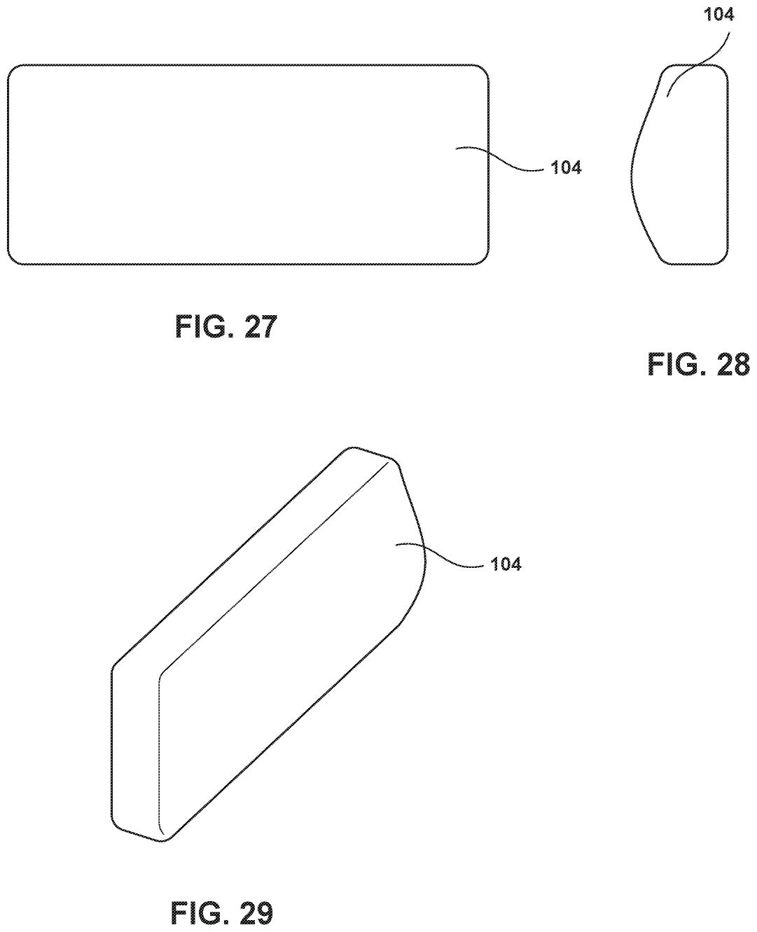

FIGS. 27-29 show various views of the back cushion 104 of the modular sofa assembly 100, in accordance with an embodiment of the present invention. The back cushion 104 is made up of fabric that is comfortable for back rest. Dimension of the back cushion 104 is 30″×12.44″×6″.

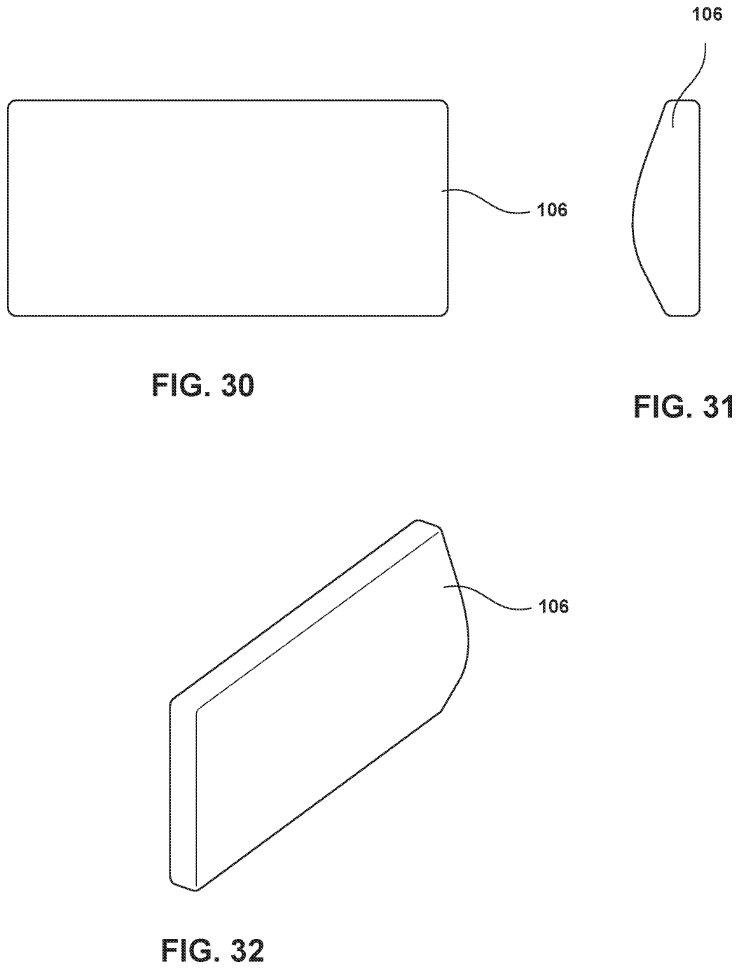

FIGS. 30-32 show various views of the side cushion 106 of the modular sofa assembly 100, in accordance with an embodiment of the present invention. The side cushion 106 is made up of fabric that is comfortable for side rest. Dimension of the side cushion 106 is 26.5″×13″×4″.

In the present invention, the modular sofa assembly 100 illustrates at least a back rest, a side rest, a square base, a first flat metal, a second flat metal, a wooden leg, and a barrel bolt. In an embodiment, the back rest is removably connected or attached to the square base. The back rest may be removably connected or attached to the square base by means of the second flat metal using one or more fasteners such as one or more nuts, bolts, and washers. Further, in one example, the back rest may be removably connected or attached to the square base at a right angle i.e., the back rest and the square base may be perpendicular to each other. In another example, the back rest may be removably connected or attached to the square base at a tilted angle (such as 5-15 degrees) such that an angle between the back rest and the square base is more than 90 degrees. In an embodiment, the back rest may be made of a wooden material, a plastic material, or a metallic material.

In an embodiment, the side rest is removably connected or attached to at least one of the square bases and the first flat metal. The side rest may be removably connected or attached to at least one of the square bases and the first flat metal by means of one or more fasteners such as one or more nuts, bolts, and washers. Further, in one example, the side rest may be removably connected or attached to the square base at a right angle i.e., the side rest and the square base may be perpendicular to each other. In such a scenario, the first flat metal may also be removably connected or attached to the square base at the right angle. In another example, the side rest may be removably connected or attached to the square base at a tilted angle (such as 5-15 degrees) such that an angle between the side rest and the square base is more than 90 degrees. In such a scenario, the first flat metal may also be removably connected or attached to the square base at the tilted angle. In an embodiment, the side rest may be made of a wooden material, a plastic material, or a metallic material.

In an embodiment, the square base is a square horizontal supporting structure that is removably connected or attached to at least one of the back rests and the side rest. In a specific embodiment of the present invention, the square base may be a wooden structure that is removably connected or attached to a metallic structure underneath the wooden structure by means of one or more fasteners such as one or more nuts, bolts, and washers. In an embodiment, the square base may also include a plurality of fold out or screw on legs such as the wooden leg. In an embodiment, the square base may be removably connected or attached to other square bases to form a large modular sofa. Further, one or more cushions such as seat cushion, back cushion, and side cushion may be placed along the square base, the back rest, and the side rest, respectively, to complete the installation of the modular sofa. Although for the simplicity of the ongoing discussion, it has been described that the square base is a square in shape. However, a person with ordinary skill in the art would understand that the scope of the present invention is not limited to the square base being square. In many other embodiments, the base may be rectangular in shape without limiting the scope of the present invention.

In an embodiment, the first flat metal is a metallic plate or a series of hollow or solid metallic pipes that are removably connected or attached to the square base. The side rest is removably connected or attached to at least the first flat metal. In an embodiment, the first flat metal may be at the right angle or the tilted angle with respect to the square base. In an embodiment, the first flat metal may also include a horizontal metallic structure that is removably connected or attached to the square base by means of one or more fasteners such as the barrel bolt. In an embodiment, the first flat metal is in place for the side rest and the first flat metal slides into the square base through the top.

In an embodiment, the second flat metal is a metallic plate or a series of hollow or solid metallic pipes that are removably connected or attached to the back rest and the square base. In an embodiment, the second flat metal may be at the right angle with respect to the square base and in parallel to the back rest. In an embodiment, the second flat metal may be removably connected or attached to at least one of the back rests and the square base by means of one or more fasteners such as one or more nuts, bolts, and washers, for example, the barrel bolt. In an embodiment, the second flat metal may slide into the square base through the top.

In an embodiment, the wooden leg is removably connected or attached to the square base. In some embodiments, the wooden leg may be a screw on leg in which the leg is removably connected or attached to the square base by means of one or more fasteners such as one or more nuts, bolts, and washers. In such a scenario, the wooden leg may not be available for folding along the plane of the square base. In some embodiments, the wooden leg may be a fold-in-fold-out leg in which the leg is removably connected or attached to the square base by means of one or more fasteners such as one or more nuts, bolts, and washers. In such a scenario, the wooden leg may be available for folding (in or out) along the below horizontal plane of the square base. In one example, the wooden leg may be removably connected or attached to a corner of the square base. In another example, the wooden leg may be removably connected or attached to a center or a near-center of the square base. Further, the wooden leg may be removably connected or attached to the square base at a right angle or a tilted angle i.e., the wooden leg is either a slanted leg or a straighten leg.

In an embodiment, the barrel bolt is a fastener that is used to lock one or more components of the modular sofa assembly. For example, the barrel bolt may be used to lock the first flat metal with the square base. In another example, the barrel bolt may be used to lock the second flat metal with the square base.

The weldment steel joiner and wood assembly may be used by a user connect two bases (such as the square base) together using the slots underneath. For example, each square base may include at least two slots. Further, the weldment steel joiner and wood assembly may include at least two joiners such as a weldment steel joiner. One of the two slots of one square base is fitted in with one weldment steel joiner and another slot of other square base is fitted in with another weldment steel joiner. The weldment steel joiner and wood assembly may also include a bottom joiner plate such as an overlapping section that overlaps the joiner points of the two bases from the bottom. The overlapping section facilitates covering of the joiner points between the two bases that have been connected together using the weldment steel joiners of the weldment steel joiner and wood assembly.

The bottom view of the square base shows a plurality of holes (such as a hole) for a plurality of legs of the square base. For example, there are 4 holes for four legs of the square base. The square base includes a plurality of slots such as a first slot and a plurality of connectors such as a first connector. The first slot and the first connector are perpendicularly to each other, and together they form a slot-connector assembly. Each side of the square base includes a pair of slot-connector assembly. One slot-connector assembly may be used for connecting the back rest. Another slot-connector assembly may be used for connecting one side rest (such as the side rest). Another slot-connector assembly may be used for connecting another side rest (such as the side rest) or a side couch. Another slot-connector assembly may be used for connecting a chaise lounge.

The bottom view of three bases includes the weldment steel joiner and wood assemblies connecting together the three bases (such as the square base) together to form a three-seater modular sofa assembly, in accordance with an embodiment of the present invention. Three square bases (such as a first square base, a second square base, and a third square base) have been connected together using four weldment steel joiner and wood assemblies such as a first weldment steel joiner and wood assembly, a second weldment steel joiner and wood assembly, a third weldment steel joiner and wood assembly, and a fourth weldment steel joiner and wood assembly. For example, the first square base and the second square base have been connected together using the first weldment steel joiner and wood assembly and the second weldment steel joiner and wood assembly. Similarly, the second square base and the third square base have been connected together using the third weldment steel joiner and wood assembly and the fourth weldment steel joiner and wood assembly.

The top view of the square base shows only the plurality of slots such as the first slot. These slots are used for removably connecting or attaching the back rest, the side rest, the side couch, or the chaise lounge. The top view of the three bases shows the weldment steel joiner and wood assemblies connecting together the three bases together to form the three-seater modular sofa assembly, in accordance with an embodiment of the present invention. For example, the first square base, the second square base, and the third square base have been connected together using the first weldment steel joiner and wood assembly, the second weldment steel joiner and wood assembly, the third weldment steel joiner and wood assembly, and the fourth weldment steel joiner and wood assembly. There is further shown an overlapping plate. The overlapping plate is a top connector plate, for example, a weldment steel joiner and wood assembly that is inserted from the top to connect the two bases such as the first square base and the second square base, and the second square base and the third square base.

A two-seater modular sofa assembly may also be obtained, in accordance with an embodiment of the present invention. The two-seater modular sofa assembly may be obtained by connecting together two one seater modular sofa assembly. The two one seater modular sofa assembly may be connected or attached together by means of one or more bottom connector legs such as the bottom connector leg.

Thus, by way of the present invention, a modular furniture system such as the modular sofa may be obtained. In an embodiment, the modular furniture system may include one or more square or rectangular bases that can be connected or attached together by means of one or more bottom connector legs to obtain various furniture such as the modular sofa that can be easily assembled and disassembled as per the requirement of the user. In the modular furniture system of the present invention, each base side should be able to connect with at least one of a back rest, a side rest, or another base. Further, the connection system should not show on any of its side. Every side should look the same. Further, the base can be square or rectangle. The square base may facilitate more configuration in comparison to the rectangle base. The size of the square base may be manufactured as per the user requirement, or it may come in predefined configuration such as 31 inches×31 inches. The seat depth for 31 inches×31 inches base may be approximately 22 inches. The remaining 9 inches of the 31 inches×31 inches base may be used for placing the cushion. In an embodiment, the modular furniture system of the present invention may also include straight rod or weldment steel joiner and wood assembly system that extends side out. The rod or weldment steel joiner and wood assembly system may facilitate additional items such as a side table. The modular furniture system of the present invention may also include hidden holes along the base. The modular furniture system of the present invention further allows full room for seat cushion.

Although particular embodiments of the invention have been described in detail for purposes of illustration, various modifications and enhancements may be made without departing from the spirit and scope of the invention.

What is claimed is:

1. A modular furniture assembly, comprising:
sofa legs including hanger bolts;
seat frames, wherein the sofa legs are removably attached to the seat frames;
steel joiner and wood assemblies, wherein two steel joiner and wood assembly are used for joining two seat frames; and
steel cap and wood assemblies that are removably attached to the seat frames and are used for at least removably connecting one or more back and side arm rests,
wherein the one or more back and side arm rests are connected in a tilted manner, and
wherein each of the back and side arm assembly is removably attached to two distinct weldment steel cap and wood assemblies.

2. The modular furniture assembly of claim 1, wherein each sofa leg is a cone-shaped leg piece.

3. The modular furniture assembly of claim 2, wherein one portion of each hanger bolt is inserted into each sofa leg and another portion is inserted into a respective seat frame.

4. The modular furniture assembly of claim 1, wherein each seat frame includes a wooden seat plate.

5. The modular furniture assembly of claim 4, wherein each seat frame is removably attached the wooden seat plate by means of metallic self-drilling flat heads.

6. The modular furniture assembly of claim 4, wherein each seat frame includes 8 seat frame slots such that two seat frame slots are along a respective edge of each side, and wherein each wooden seat plate includes 8 wooden seat plate slots such that two wooden seat plate slots are along a respective edge of each side.

7. The modular furniture assembly of claim 6, wherein the wooden seat plate slots parallelly matches with the respective seat frame slots when the wooden seat plate is removably placed over the seat frame, and wherein the weldment steel cap and wood assembly is inserted into each of these slots from the top.

8. The modular furniture assembly of claim 1, wherein each back and side arm assembly includes two weldment steel arm pieces and two wood pieces for arm rest, and wherein one weldment steel arm piece and one wood piece for arm rest are removably attached to a weldment steel cap and wood assembly.

9. The modular furniture assembly of claim 8, wherein each back and side arm assembly further includes a back and side rest wooden piece that is removably attached to the two weldment steel arm pieces by means of screws.

10. The modular furniture assembly of claim 1, wherein each weldment steel cap and wood assembly includes one piece of weldment steel cap, one wooden piece, and two pieces of rounded head screws.

11. The modular furniture assembly of claim 10, wherein each rounded head screw is made up of zinc plated steel.

12. The modular furniture assembly of claim 10, wherein the weldment steel cap is removably attached to the wooden piece by means of the two pieces of rounded head screws.

13. The modular furniture assembly of claim 1, wherein each weldment steel joiner and wood assembly includes one wooden piece for connector, two pieces of wooden steel caps, and four pieces of rounded head screws.

14. The modular furniture assembly of claim 13, wherein each weldment steel cap is removably attached to the wooden piece for connector by means of the two pieces of rounded head screws.

15. The modular furniture assembly of claim 1, wherein at least one seat cushion, at least one back cushion, and at least two side cushions are used with the assembly for obtaining a modular sofa.
